(19) United States
(12) Patent Application Publication
(10) Pub. No.: US 2025/0121316 A1
(43) Pub. Date: Apr. 17, 2025

(54) OXIDATIVELY STABLE ORGANOSILICATES FOR CO2 CAPTURE

(71) Applicant: EXXONMOBIL TECHNOLOGY AND ENGINEERING COMPANY, Spring, TX (US)

(72) Inventors: Corey J. KAMINSKY, Maplewood, NJ (US); Shabab A. Abedi, Cedar Knolls, NJ (US); Hilda B. Vroman, Piscataway, NJ (US); Wesley Sattler, Bedminster, NJ (US)

(21) Appl. No.: 18/915,714

(22) Filed: Oct. 15, 2024

Related U.S. Application Data
(60) Provisional application No. 63/590,593, filed on Oct. 16, 2023.

(51) Int. Cl. B01D 53/04; B01J 20/26

(52) U.S. Cl. CPC B01D 53/04; B01J 20/262; B01D 2253/202; B01D 2253/306; B01D 2253/311; B01D 2257/504; B01J 2220/4812

(57) ABSTRACT

Amine-functionalized organosilica materials are provided that have improved stability when exposed to oxidizing/oxygen-containing environments during cycling of temperature, such as the cycling of temperature that occurs when using a material as a sorbent during successive adsorption/desorption cycles. Methods of performing CO₂ sorption/desorption with improved stability of the organosilica sorbent material are also provided. The improved stability is achieved in part by using amine-functionalized organosilica materials where the amine-functionalization is provided by functional groups that include primary amines but do not include secondary amines. Still further improvements in stability can be achieved when the functionalization is provided by a functional group that includes a primary amine while also not having any hydrogens on a carbon atom that is in the beta position relative to the primary amine.

### CROSS REFERENCE TO RELATED APPLICATION

This non-provisional patent application claims priority to U.S. provisional patent app. No. 63/590,593, filed Oct. 16, 2023, and titled “AMINE-FUNCTIONAL AEROGELS FOR ACID GAS REMOVAL,” the entire contents of which is incorporated herein by reference

### FIELD OF THE INVENTION

Amine-functionalized aerogel compositions are provided that are capable of sorption and desorption of acid gas components.

### BACKGROUND OF THE INVENTION

Porous inorganic solids have found great utility as catalysts and separation media for industrial application. In particular, mesoporous materials, such as silicas and aluminas, having a periodic arrangement of mesopores are attractive materials for use in adsorption, separation and catalysis processes due to their uniform and tunable pores, high surface areas and large pore volumes. The pore structure of such mesoporous materials is large enough to absorb large molecules and the pore wall structure can be as thin as about 1 nm. Further, such mesoporous materials are known to have large specific surface areas (e.g., 1000 m²/g) and large pore volumes (e.g., 1 cm³/g). For these reasons, such mesoporous materials enable reactive catalysts, adsorbents composed of a functional organic compound, and other molecules to rapidly diffuse into the pores and therefore, can be advantageous over zeolites, which have smaller pore sizes. Consequently, such mesoporous materials can be useful not only for catalysis of high-speed catalytic reactions, but also as large capacity adsorbents.

It was further discovered that the inclusion of some organic groups in the mesoporous framework can provide adjustable reactive surfaces and also contributes to uniformity in pore size, higher mechanical strength, and hydrothermal stability of the material. Thus, mesoporous organosilica materials can exhibit unique properties compared to mesoporous silica such as enhanced hydrothermal stability, chemical stability, and mechanical properties. Organic groups can be incorporated using bridged silsesquioxane precursors of the form Si—R—Si to form mesoporous organosilicas.

Mesoporous organosilicas are conventionally formed by the self-assembly of the silsequioxane precursor in the presence of a structure directing agent, a porogen and/or a framework element. The precursor is hydrolysable and condenses around the structure directing agent. These materials have been referred to as Periodic Mesoporous Organosilicates (PMOs), due to the presence of periodic arrays of parallel aligned mesoscale channels. For example, Landskron, K., et al. [Science, 302:266-269 (2003)] report the self-assembly of 1,3,5-tris[diethoxysila]cylcohexane [(EtO)₂SiCH₂]₃ in the presence of a base and the structure directing agent, cetyltrimethylammonium bromide to form PMOs that are bridged organosilicas with a periodic mesoporous framework, which consist of SiO₃R or SiO₂R₂ building blocks, where R is a bridging organic group. In PMOs, the organic groups can be homogenously distributed in the pore walls. U.S. Pat. Pub. No. 2012/0059181 reports the preparation of a crystalline hybrid organic-inorganic silicate formed from 1,1,3,3,5,5 hexaethoxy-1,3,5 trisilyl cyclohexane in the presence of NaAlO₂ and base. U.S. Patent Application Publication No. 2007/003492 reports preparation of a composition formed from 1,1,3,3,5,5 hexaethoxy-1,3,5 trisilyl cyclohexane in the presence of propylene glycol monomethyl ether.

However, the use of a structure directing agent, such as a surfactant, in the preparation of an organosilica material, such as a PMO, requires a complicated, energy intensive process to eliminate the structure directing agent at the end of the preparation process. This limits the ability to scale-up the process for industrial applications. Therefore, there is a need to provide additional organosilica materials with a desirable pore diameter, pore volume and surface area. Further, there is a need to provide such organosilica materials that can be prepared by a method that can be practiced in the absence of a structure directing agent, a porogen or surfactant.

U.S. Pat. No. 10,207,249 describes organosilica materials and uses thereof.

### SUMMARY OF THE INVENTION

In an aspect, a method for performing sorption and desorption of CO₂ in an oxidizing environment is provided. The method includes providing an organosilica material comprising a polymer of one or more repeat units of Formula (1),

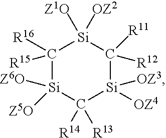

the organosilica material having a nitrogen content of 2.0 wt % to 9.5 wt %, a surface area of 100 m²/g or more, and a pore volume of 0.15 cm³/g or more. The organosilica material contains primary amines while being substantially free of secondary amines. The method further includes exposing the organosilica material to CO₂ under sorption conditions comprising a sorption temperature and a sorption pressure to form an organosilica material comprising sorbed CO₂. Additionally, the method includes desorbing at least a portion of the sorbed CO₂ under desorption conditions comprising at least one of a desorption temperature higher than the sorption temperature and a desorption pressure lower than the sorption pressure, wherein a) the sorption conditions comprise a sorption atmosphere containing 1.0 vol % or more of O₂, b) the desorption conditions comprises a desorption atmosphere containing 1.0 vol % or more of O₂, or c) a combination of a) and b). For the organosilica material, Z¹, Z², Z³, Z⁴, Z⁵, and Z⁶ each independently represent a hydrogen atom, a C₁-C₄ alkyl group, a bond to a silicon atom of another repeat unit of Formula (1), a bond to an aminosilyl group comprising a primary amine, a bond to a silicon atom that is bonded to three alkoxy groups, or a bond to a silicon atom of a secondary repeat unit, the secondary repeat unit optionally comprising an acyclic alkoxy silane. For the organosilica material, R¹¹, R¹², R¹³, R¹⁴, R¹⁵, and R¹⁶ each independently represent a hydrogen atom or a C₁-C₄ alkyl group.

In another aspect, an organosilica material is provided comprising a polymer of at least one repeat unit of Formula (1),

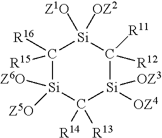

wherein Z¹, Z², Z³, Z⁴, Z⁵, and Z⁶ each independently represent a hydrogen atom, a C₁-C₄ alkyl group, a bond to a silicon atom of another repeat unit of Formula (1), a bond to an aminosilyl group having a primary amine with a beta carbon that is not bonded to hydrogens, a bond to a silicon atom that is bonded to three alkoxy groups, or a bond to a silicon atom of a secondary repeat unit, the secondary repeat unit optionally comprising an acyclic alkoxy silane. For the organosilica material, R^{D}, R¹², R¹³, R¹⁴, R¹⁵, and R¹⁶ each independently represent a hydrogen atom or a C₁-C₄ alkyl group, the organosilica material being substantially free of secondary amines. The organosilica material has a nitrogen content of 2.0 wt % to 9.5 wt %, a surface area of 100 m²/g or more, and/or a pore volume of 0.15 cm³/g or more.

### BRIEF DESCRIPTION OF THE DRAWINGS

FIG. 1 shows a depiction of hexa-ethoxy trisilacyclohexane.

FIG. 2 shows a depiction of aminosilane reagents that have primary amines.

FIG. 3 shows a depiction of comparative aminosilane reagents that contain secondary amines.

FIG. 4 shows a process flow for forming an intermediate gel.

FIG. 5 shows an example of a repeat unit of the polymer corresponding to an organosilica material.

FIG. 6 shows an example of a precursor organosilane for forming the repeat unit shown in FIG. 5.

FIG. 7 shows a depiction of penta-ethoxy mono-triethoxysila-trisilacyclohexane.

FIG. 8 shows CO₂ sorption capacity over time during exposure to an oxidative environment for samples prepared using supercritical CO₂ as a drying method.

FIG. 9 shows CO₂ sorption capacity over time during exposure to an oxidative environment for samples prepared using vacuum drying as a drying method.

### DETAILED DESCRIPTION OF THE INVENTION

### Overview

In various aspects, amine-functionalized organosilica materials are provided that have improved stability when exposed to oxidizing/oxygen-containing environments during cycling of temperature, such as the cycling of temperature that occurs when using a material as a sorbent during successive adsorption/desorption cycles. Methods of performing CO₂ sorption/desorption with improved stability of the organosilica sorbent material are also provided. The improved stability is achieved in part by using amine-functionalized organosilica materials where the amine-functionalization is provided by functional groups that include primary amines but do not include secondary amines. Still further improvements in stability can be achieved when the functionalization is provided by a functional group that includes a primary amine while also not having any hydrogens on a carbon atom that is in the beta position relative to the primary amine. It is noted that tertiary amines can be present while substantially retaining the oxidative stability benefit.

Although amine-functionalized organosilica materials have potential as sorbents for CO₂ sorption and desorption, one of the challenges of using such materials in commercial scale processes is the stability of the materials when exposed to oxygen. During a typical sorption/desorption cycle, a sorbent material is exposed to temperature swings, so that adsorption can occur at a colder temperature followed by desorption to regenerate the sorbent for the next cycle. Conventionally, when amine-functionalized organosilica materials are used for CO₂ sorption in environments where oxygen (O₂) is also present, the exposure to oxygen while cycling the temperature between sorption and desorption conditions results in degradation of the CO₂ sorption capacity of the amine-functionalized organosilica material.

It has been discovered that for amine-functionalized organosilica materials, the stability of a material in the presence of an oxygen-containing environment is improved when the amine-functionalization corresponds to only primary amines. During sorption/desorption cycles in the presence of an oxygen-containing environment, materials that are functionalized using secondary amines have an increased rate of degradation relative to materials that are functionalized only with primary amines. The stability of primary amines in an oxygen-containing environment can be further enhanced when the beta carbon relative to the primary amine does not include any hydrogens. A “beta carbon” has the expected definition. The carbon atom a primary amine is bonded to is the alpha carbon. Any carbons bonded to the alpha carbon are beta carbons. Dimethyl aminobutyl trimethoxysilane is an example of an aminosilane compound with a primary amine without hydrogens on the beta carbon.

An amine-functionalized organosilica that has primary amines, but that is substantially free of secondary amines, can provide improved oxidative stability for sorption/desorption processes that are performed in the presence of O₂. In some aspects, the amine-functionalized organosilica materials can be used for sorption and/or desorption steps that have an atmosphere containing 0.1 vol % to 22 vol % O₂, or 0.1 vol % to 15 vol %, or 0.1 vol % to 10 vol %, or 1.0 vol % to 22 vol % O₂, or 1.0 vol % to 15 vol %, or 1.0 vol % to 10 vol %, or 2.0 vol % to 22 vol % O₂, or 2.0 vol % to 15 vol %, or 2.0 vol % to 10 vol %, or 5.0 vol % to 22 vol % O₂, or 5.0 vol % to 15 vol %, or 10 vol % to 22 vol %, or 15 vol % to 22 vol %. It is noted that in some aspects where the sorption atmosphere includes 1.0 vol % or more of O₂, the desorption atmosphere may contain low but non-zero amounts of O₂, such as 0.005 vol % 02 to 0.1 vol % 02.

Some sorption processes can correspond to dilute CO₂ atmospheres, such as direct air capture applications. In such processes, the atmosphere during sorption can include 300 vppm to 600 vppm CO₂. It is noted that a typical concentration for CO₂ in air is roughly 400 vppm. More generally, dilute CO₂ atmospheres can include 300 vppm to 20,000 vppm (2.0 vol %) CO₂, or 300 vppm to 5000 vppm, or 300 vppm to 3000 vppm, or 1000 vppm to 20,000 vppm, or 1000 vppm to 5000 vppm, or 1000 vppm to 3000 vppm. Other sorption processes can focus on sorption of CO₂ from flue gases where a hydrocarbon fuel is combusted. In such processes, the atmosphere during sorption can include 2.0 vol % to 20 vol % of CO₂, or 2.0 vol % to 15 vol %, or 2.0 vol % to 10 vol %, or 2.0 vol % to 6.0 vol %, or 3.5 vol % to 20 vol % of CO₂, or 3.5 vol % to 15 vol %, or 3.5 vol % to 10 vol %, 3.5 vol % to 6.0 vol %, or 8.0 vol % to 20 vol %, or 8.0 vol % to 15 vol %. Thus, depending on the aspect, the CO₂ concentration in the input gas flow for sorption can have a CO₂ concentration ranging from 300 vppm to 20 vol %, or 1000 wppm to 20 vol %, or 300 vppm to 6.0 vol %, or 1000 vppm to 6.0 vol %.

Sorption and desorption steps typically have an associated temperature. For a sorption step, the sorption temperature can be 0° C. to 80° C., or 0° C. to 50° C., or 20° C. to 80° C., or 20° C. to 50° C. For a desorption step, the desorption temperature can be 80° C. to 160° C., or 80° C. to 120° C., or 100° C. to 160° C.

### Definitions

For purposes of this invention and the claims hereto, the numbering scheme for the Periodic Table Groups is according to the IUPAC Periodic Table of Elements.

The terms “substituent”, “radical”, “group”, and “moiety” may be used interchangeably.

As used herein, and unless otherwise specified, the term “Cₙ” means hydrocarbon(s) having n carbon atom(s) per molecule, wherein n is a positive integer.

As used herein, and unless otherwise specified, the term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n.

A hydrocarbonaceous compounds refers to an organic compound that differs from a hydrocarbon in that one or more atoms different from carbon or hydrogen are present in the compound.

As used herein, and unless otherwise specified, an acyclic compound, group, or substituent refers to a compound, group, or substituent that does not include a ring structure.

As used herein, and unless otherwise specified, the term “alkyl” refers to a saturated hydrocarbon radical having from 1 to 12 carbon atoms (i.e. C₁-C₁₂ alkyl), particularly from 1 to 8 carbon atoms (i.e. C₁-C₈ alkyl), particularly from 1 to 6 carbon atoms (i.e. C₁-C₆ alkyl), and particularly from 1 to 4 carbon atoms (i.e. C₁-C₄ alkyl). Examples of alkyl groups include, but are not limited to, methyl, ethyl, propyl, butyl, pentyl, hexyl, heptyl, octyl, decyl, and so forth. The alkyl group may be linear, branched or cyclic. “Alkyl” is intended to embrace all structural isomeric forms of an alkyl group. For example, as used herein, propyl encompasses both n-propyl and isopropyl; butyl encompasses n-butyl, sec-butyl, isobutyl and tert-butyl and so forth. As used herein, “C₁ alkyl” refers to methyl (—CH₃), “C₂ alkyl” refers to ethyl (—CH₂CH₃), “C₃ alkyl” refers to propyl (—CH₂CH₂CH₃) and “C₄ alkyl” refers to butyl (e.g. —CH₂CH₂CH₂CH₃, —(CH₃)CHCH₂CH₃, —CH₂CH(CH₃)₂, etc.). As used herein, and unless otherwise specified, the term “alkylene” refers to a divalent alkyl moiety containing 1 to 12 carbon atoms (i.e. C₁-C₁₂ alkylene) in length and meaning the alkylene moiety is attached to the rest of the molecule at both ends of the alkyl unit. For example, alkylenes include, but are not limited to, —CH₂—, —CH₂CH₂—, —CH(CH₃)CH₂—, —CH₂CH₂CH₂—, etc. The alkylene group may be linear or branched.

As used herein, and unless otherwise specified, an aminosilane refers to a hydrocarbonaceous compound that includes at least one silicon atom and at least one nitrogen atom that corresponds to an amine nitrogen, with an alkyl group between the at least one silicon atom and the at least one nitrogen atom. An aminosilyl group refers to a hydrocarbonaceous radical that includes at least one silicon atom and at least one nitrogen atom that corresponds to an amine nitrogen, with an alkyl group between the at least one silicon atom and the at least one nitrogen atom.

As used herein, and unless otherwise specified, the term “alkoxy” refers to —O-alkyl containing from 1 to about 10 carbon atoms. The alkoxy may be straight-chain or branched-chain. Non-limiting examples include methoxy, ethoxy, propoxy, butoxy, isobutoxy, tert-butoxy, pentoxy, and hexoxy. “C₁ alkoxy” refers to methoxy, “C₂ alkoxy” refers to ethoxy, “C₃ alkoxy” refers to propoxy and “C₄ alkoxy” refers to butoxy. Further, as used herein, “OMe” refers to methoxy and “OEt” refers to ethoxy.

As used herein, the term “hydroxyl” refers to an —OH group.

As used herein, the term “mesoporous” refers to solid materials having pores that have a diameter within the range of from about 2 nm to about 50 nm.

As used herein, the term “organosilica” refers to an organosiloxane compound that comprises one or more organic groups bound to two or more Si atoms.

As used herein, the term “silanol” refers to a Si—OH group.

As used herein, the term “silanol content” refers to the percent of the Si—OH groups in a compound and can be calculated by standard methods, such as NMR.

As used herein, the terms “structure directing agent,” “SDA,” and/or “porogen” refer to one or more compounds added to the synthesis media to aid in and/or guide the polymerization and/or polycondensing and/or organization of the building blocks that form the organosilica material framework. Further, a “porogen” is understood to be a compound capable of forming voids or pores in the resultant organosilica material framework. As used herein, the term “structure directing agent” encompasses and is synonymous and interchangeable with the terms “templating agent” and “template.”

As used herein, and unless otherwise specified, the term “adsorption” includes physisorption, chemisorption, and condensation onto a solid material and combinations thereof.

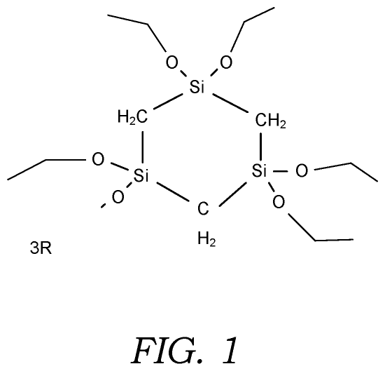

In this discussion, the ring structure corresponds to the atoms that form the cyclic structure. The members of a ring structure can be identified as the atoms that form a continuous loop without having to trace a path through an atom more than once. For example, in cyclohexane, all of the carbon atoms are part of the ring structure, but none of the hydrogen atoms are part of the ring structure. As another example, in the compound shown in FIG. 1, the ring structure includes the three silicon atoms and three carbon atoms that correspond to the six membered ring. None of the ethoxy groups shown in FIG. 1 are part of the ring structure.

Aminosilane Precursors with Primary Amines

One synthesis route for making organosilica materials is based on condensation of an alkoxy-substituted cyclic organosilane in the presence of an aminosilane precursor. The primary amines, optionally with no hydrogens on the beta carbon, can be introduced into the organosilica material by using an appropriate aminosilane precursor.

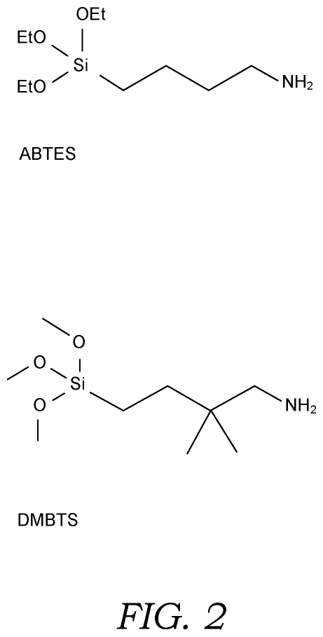

FIG. 2 shows two examples of aminosilane precursors with primary amines that can be used to form amine-functionalized organosilicas materials. FIG. 2 shows aminobutyl-triethoxysilane (ABTES) and dimethyl-aminobutyl-trimethoxysilane (DMBTS). ABTES is an example of an aminosilane precursor that produces amino-functionalized organosilicas with primary amines. Aminopropyl-triethoxysilane (APTES) is another example of an aminosilane precursor that can be used to produce amine-functionalized organosilicas with primary amines. FIG. 2 also shows the structure of DMBTS. Due to the additional methyl groups, DMBTS produces amine-functionalized organosilicas with primary amines, where the beta carbon does not have any hydrogens. Aminopropyl-triethoxysilane (APTES) is another example of an aminosilane precursor that produces amine-functionalized organosilicas with primary amines.

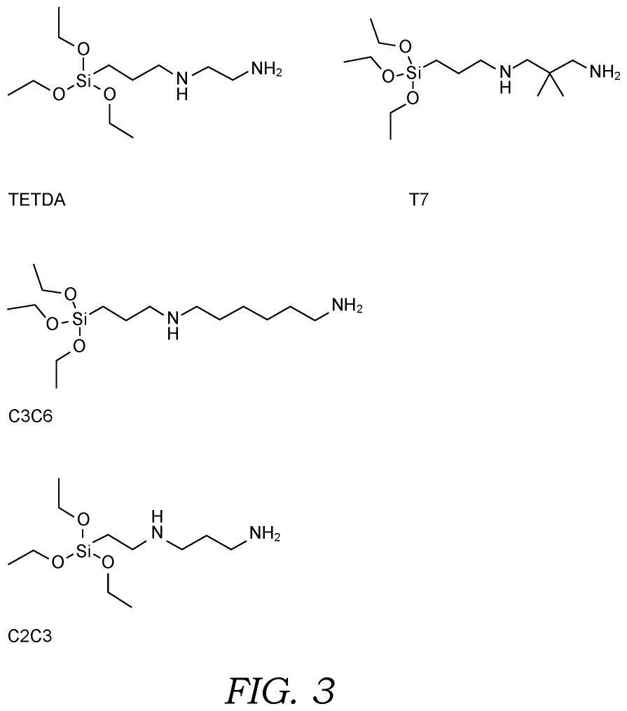

The structures shown in FIG. 2 are in contrast to the aminosilane precursors shown in FIG. 3. FIG. 3 shows structures for diamines that includes both a primary and a secondary amine, with differing chain lengths between the amines and the triethoxy silica functional groups. The TETDA molecule includes a propyl group between the secondary amine and the triethoxysilane group and an ethyl group between the secondary amine and the primary amine. The C3C6 molecule includes a propyl and a hexyl group, while the C2C3 molecule includes an ethyl and a propyl group. Finally, the precursor labeled T7 is similar to TETDA, but also includes a propyl group with two methyl groups on the beta carbon relative to the primary amine (a neopentyl group), so that no hydrogens are present on the beta carbon relative to the primary amine.

Conventionally, the aminosilane precursors shown in FIG. 3 would be considered advantageous for forming an amine-functionalized organosilica material, as the each aminosilane precursor includes both a primary and a secondary amine, thus potentially increasing the amine density in the resulting amine-functionalized organosilica material. However, because each of the precursors included in FIG. 3 also includes a secondary amine, the resulting organosilica materials are susceptible to increased degradation under oxidative conditions. It is noted that even with no hydrogens on the beta carbon relative to the primary amine, the T7 precursor still results in an amine-functionalized organosilica material with increased susceptibility to oxidation, due to the presence of the secondary amine.

### Organosilica Materials and Synthesis of Gel Intermediate—Example of Condensation Method

In various aspects, amine-functionalized organosilicas can be formed based on condensation of an alkoxy-substituted cyclic organosilane in the presence of an aminosilane precursor. This type of process is a single step synthesis process that forms an amine-functionalized polymer. The precursors for the one-step synthesis process include an alkoxy-substituted cyclic organosilane and an aminosilane precursor. It is noted that the alkoxy-substituted cyclic organosilane does not quite correspond to a “monomer” for forming the polymer, as the polymer is not simply the condensation product of the alkoxy-substituted cyclic organosilane. Instead, at least a portion of the alkoxy-substituted cyclic organosilanes also react with the aminosilane precursor during the synthesis, so that the resulting organosilica material is also amine-functionalized. Optionally, a gelator or gelling agent can also be included. For example, an acyclic alkoxy silane compound can be used during the condensation to provide a secondary repeat unit that facilitates formation of the gel. Thus, this synthesis corresponds to a solgel condensation of a cyclic organosilane precursor in the presence of an aminosilane precursor. The product of this condensation would be expected to possess anchored amine functional groups distributed throughout on both external surface and within the bulk of the network structure. The condensation method involves forming an intermediate gel based on a precursor corresponding to a cyclic organosilane, such as a trisilacyclohexane, combined with an aminosilane precursor, such as for example, DMBTS.

The resulting intermediate gel is then dried. Any convenient type of drying method may be used, such as drying by heating and/or vacuum drying. In some aspects, the drying can correspond to at least one of a supercritical drying process and a freeze drying process. By using a supercritical drying process and/or a freeze drying process, an amine-functionalized organosilica material can be formed that has improved properties for sorption of CO₂. In particular, the amount of nitrogen that can be incorporated into the amine-functionalized organosilica materials while still increasing the CO₂ sorption capacity can be substantially increased.

This type of synthesis, based on condensation of an alkoxy-substituted cyclic organosilane in the presence of an aminosilane precursor, provides at least two unexpected benefits for the resulting amine-functionalized organosilica. First, the amine-functionalized organosilica is formed by a single-step method without the use of a templating agent. This simplifies synthesis and reduces costs associated with the synthesis. Additionally, by using supercritical CO₂ and/or freeze-drying as the drying step(s) to form the resulting gel, improved CO₂ sorption capacity can be achieved relative to the amine loading of the organosilica. This improved CO₂ sorption capacity can be achieved for organosilica materials with elevated nitrogen contents, such as organosilica materials with nitrogen content of 4.0 wt % nitrogen or more.

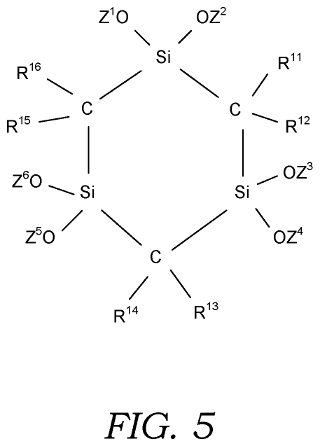

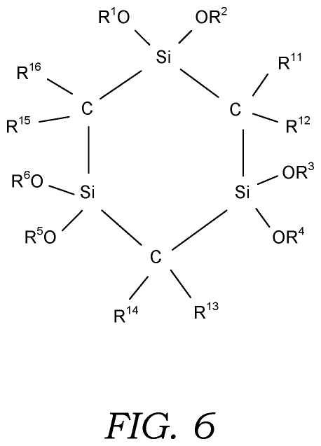

The organosilica material can correspond to a polymer that includes one or more of the repeat units according to the structure shown in FIG. 5 (Formula 1). FIG. 6 shows an example of a corresponding cyclic organosilane precursor (Formula 2) to produce a polymer that includes repeat units of the type shown in FIG. 5. In FIG. 5, Z¹, Z², Z³, Z⁴, Z⁵, and Z⁶ each independently represent a hydrogen atom, a C₁-C₄ alkyl group, a bond to a silicon atom of another repeat unit of Formula 1, a bond to a silicon atom of an amino-silyl, a bond to a silicon atom that is bonded to three alkoxy groups, or a bond to a silicon atom of a secondary repeat unit, such as a repeat unit comprising an acyclic alkoxy-silyl. In other words, each “Z” location shown in FIG. 5 can correspond to a silanol group, an alkoxy group, a bond to another repeat unit, a bond to an aminosilyl (derived from the aminosilane precursor) that provides the amine functionalization for the polymer, a bond to a siloxy group, or a bond to a secondary repeat unit. It is noted that preferably, only one of Z¹, Z², Z³, Z⁴, Z⁵, and Z⁶ will correspond to a silicon atom that is bonded to three alkoxy groups, as such structures do not contribute to forming a network. In FIG. 5, R¹¹, R¹², R¹³, R¹⁴, R¹⁵, and R¹⁶ each independently represent a hydrogen atom or a C₁-C₄ alkyl group. In aspects where each of R¹¹, R¹², R¹³, R¹⁴, R¹⁵, and R¹⁶ corresponds to a hydrogen atom, the structure in FIG. 5 corresponds to the type of repeat unit present when a hexa-alkoxy trisliacyclohexane is used to make the mixture for forming the gel for the organosilica material.

FIG. 6 shows an example of a cyclic organosilane precursor compound that can be used for forming a gel. In aspects where each of R¹¹, R¹², R¹³, R¹⁴, R¹⁵, and R¹⁶ corresponds to a hydrogen atom, and where each of R¹, R², R³, R⁴, R⁵, and R⁶ correspond to a C₂ alkyl group, FIG. 6 corresponds to 1,1,3,3,5,5-hexaethoxytrisilacyclohexane, which can be referred to as “3R”.

It is noted that the aminosilane precursors are incorporated into the polymer as terminal groups. Therefore, the aminosilane precursors are not referred to herein as monomers. However, in some aspects, alkoxy-substituted acyclic silanes may also be present in the condensation mixture and can serve as secondary repeat units that also form part of the polymer network. Such alkoxy-substituted acyclic silanes that serve as precursors (or monomers) for secondary repeat units in the polymer are defined herein as gelator compounds.

In some aspects where supercritical CO₂ drying is used, the nitrogen content of the resulting organosilica materials can be 4.0 wt % to 10 wt %, relative to the weight of the organosilica material, or 4.0 wt % to 9.5 wt %, or 4.0 wt % to 8.3 wt %, or 4.5 wt % to 10 wt %, or 4.5 wt % to 9.5 wt %, or 4.5 wt % to 8.3 wt %, or 5.5 wt % to 10 wt %, or 5.5 wt % to 9.5 wt %, or 5.5 wt % to 8.3 wt %, or 6.5 wt % to 10 wt %, or 6.5 wt % to 9.5 wt %, or 6.5 wt % to 8.3 wt %.

It is noted that the use of supercritical CO₂ drying for the production of high surface area, high porosity and low density silica aerogels is known conventionally. Conventionally, using supercritical CO₂ for drying of conventional aerogels is reported to provide high gas diffusion rates in these materials relative to conventional silica substrates. Supercritical CO₂ drying has also been found to reduce mass transfer resistance in amine-functionalized organosilica formed by conventional two-step synthesis methods.

In other aspects, including in some aspects where conventional drying techniques are used, the nitrogen content of the resulting organosilica materials can be 2.0 wt % to 9.5 wt %, relative to the weight of the organosilica material, or 2.0 wt % to 8.3 wt %, or 2.0 wt % to 6.5 wt %, or 4.0 wt % to 9.5 wt %, or 4.0 wt % to 8.3 wt %, or 4.0 wt % to 6.5 wt %, or 5.5 wt % to 9.5 wt %, or 5.5 wt % to 8.3 wt %, or 6.5 wt % to 9.5 wt %, or 6.5 wt % to 8.3 wt %.

An alkoxy-substituted cyclic organosilane is the primary component for forming the organosilica material. An example of an alkoxy-substituted cyclic organosilane is an alkoxy-substituted silacyclohexane, such as hexa-ethoxy trisilacyclohexane. In this discussion, hexa-ethoxy trisilacyclohexane may be referred to as “3R”. FIG. 1 shows a structural representation of hexa-ethoxy trisilacyclohexane.

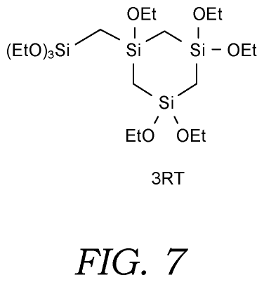

It is noted that in some aspects, instead of using only an alkoxy-substituted cyclic organosilane, a mixture of an alkoxy-substituted cyclic organosilane, such hexa-ethoxy trisilacyclohexane, and an alkoxy-substituted siloxy-substituted cyclic organosilane can be used. An example of an alkoxy-substituted siloxy-substituted cyclic organosilane is an alkoxy-substituted, mono-siloxy-substituted cyclic organosilane, such as penta-ethoxy mono-(triethoxy)siloxy-trisilacyclohexane (i.e., for one silicon position in the ring, the ethoxy group is replaced with a siloxy group). An example of penta-ethoxy mono-(triethoxy)siloxy-trisilacyclohexane is shown in FIG. 7.

In various aspects, the alkoxy-substituted cyclic organosilane can include 3 or more silicon atoms in the ring structure. Optionally, the ring structure can correspond to a 6-membered ring. Optionally, the ring structure can include between 5 to 10 atoms that are part of the cyclic ring structure. Optionally, the ring structure can correspond to a single ring. For the carbons in the ring structure, one option is for the ring carbons to have two hydrogen substituents. In other aspects, one or more of the carbons in the ring structure can have a C₁-C₄ substituent. Larger alkyl groups could be possible, so long as steric hindrance from the alkyl groups does not prevent gel formation. For the alkoxy groups attached to the silicon atoms, the alkoxy groups can contain 1 to 6 carbons, or 2 to 6 carbons, or 1 to 4 carbons, or 2 to 4 carbons. In some aspects, the alkoxy groups attached to the silicon atoms in a single ring can each have the same number of carbon atoms (e.g., all alkoxy groups are methoxy, or all alkoxy groups are ethoxy).

The aminosilane precursor provides the amine-functionalization for the organosilica. Examples of aminosilane precursors that contain a primary amine without including a secondary amine are aminobutyl-triethoxysilane (ABTES), aminopropyl-triethoxysilane (APTES), and dimethyl-aminobutyl-trimethoxysilane (DMBTS).

In various aspects, each of the aminoalkyl groups in the aminosilane precursor can correspond to a C₁-C₆ aminoalkyl. Optionally, each of the aminoalkyl groups can have the same chain length. In some aspects, the alkoxy groups can contain 1 to 6 carbons, or 2 to 6 carbons, or 1 to 4 carbons, or 2 to 4 carbons. In some aspects, each of the alkoxy groups attached to the silicon atom can have the same number of carbon atoms (e.g., all alkoxy groups are methoxy, or all alkoxy groups are ethoxy). It is noted that the alkyl groups can optionally be branched, unbranched, or a mixture of branched and unbranched.

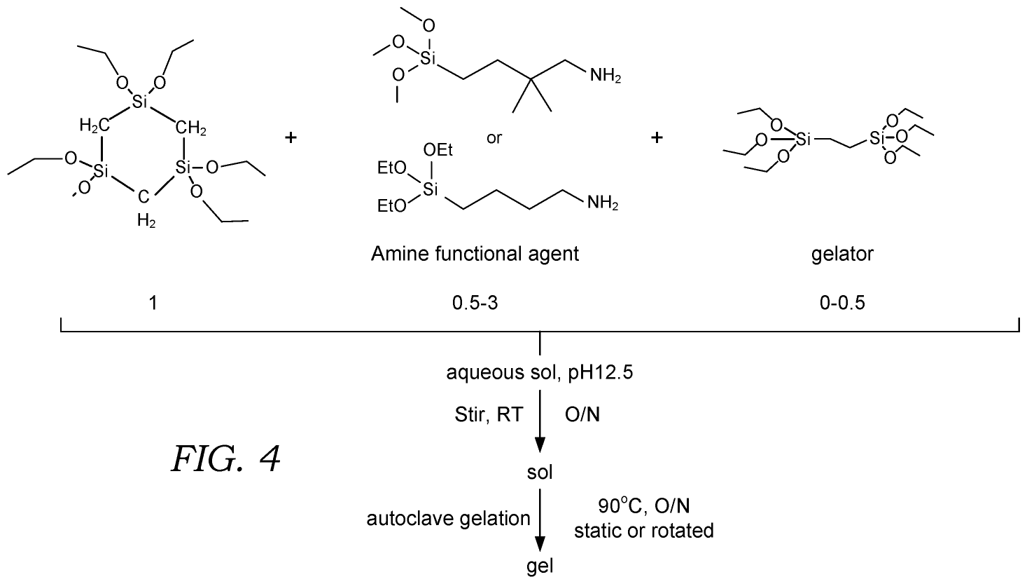

In aspects where a gelator or gelling agent is used, the gelator or gelling agent corresponds to an acyclic polyalkoxysilane compound. The gelator can optionally correspond to an alkyl polyalkoxysilane, or the gelator can optionally correspond to an alkylamine alkoxysilane, or a combination thereof. An example of an alkyl polyalkoxysilane is 1,2-bis(triethoxysilyl)ethane. This is shown as an example of a “gelator” compound in FIG. 4. In some aspects, the alkoxy groups attached to the silicon atoms in the gelator can contain 1 to 6 carbons, or 2 to 6 carbons, or 1 to 4 carbons, or 2 to 4 carbons. In some aspects, alkyl and/or aminoalkyl groups in the gelator can include 1 to 4 carbons.

To form an organosilica compound, the alkoxy-substituted cyclic organosilane and the aminosilane precursor can be combined in a molar ratio of 1:0.5-3.0, or 1:1.0-3.0, or 1:0.5-2.0. In aspects where an optional gelator or gelling agent is used, the alkoxy-substituted cyclic organosilane and the gelator or gelling agent can be combined in a molar ratio of 1:0.2-0.8, or 1:0.2-0.6, or 1:0.4-0.8. Additionally or alternatively, in aspects where additional precursors corresponding to one or more additional types of repeat units are present in the synthesis mixture, the alkoxy-substituted cyclic organosilane and the additional precursors can be combined in a molar ratio of 1:0.2-0.8, or 1:0.2-0.6, or 1:0.4-0.8. In some aspects, to form the organosilica compound, the reagents can be mixed together in an aqueous solution at a pH of 10.5-12.5. The mixture can be mixed for 5.0 hours to 48 hours, such as overnight. More generally, to form the organosilica compound, the reagents can be mixed together in an aqueous solution that has either an acidic or a basic pH. In some aspects, the pH can be roughly 5.0 or less, or 4.0 or less, such as down to 1.0 or possibly still lower. In other aspects, the pH can be roughly 9.5 to 12.5, or 10.5 to 12.5. As a practical matter using an acid wash is effective, but requires additional wash steps relative to using a basic pH to recover the free-base form of the amine-functionalized organosilica material. The mixture can be mixed for 5.0 hours to 48 hours.

After this initial mixing, the mixture is aged to allow for gel formation. Ageing can be performed under a variety of conditions. For example, the mixture can be aged at a temperature of 10° C. to 300° C., or 50° C. to 300° C., or 10° C. to 200° C., or 50° C. to 200° C., or 50° C. to 150° C., or 70° C. to 150° C., or 50° C. to 110° C., or 70° C. to 110° C. The mixture can be maintained at the temperature for 20 hours to 150 hours, or 20 to 60 hours. This produces a gel intermediate. Optionally, the heating of the mixture can be performed in a rotating oven or a stirred reactor to facilitate even heating. After aging, the pre-product is dried to obtain the organosilica material.

The nitrogen content of the resulting organosilica materials (after drying) can be 2.0 wt % to 10 wt %, relative to the weight of the organosilica material, or 2.0 wt % to 9.5 wt %, or 2.0 wt % to 8.3 wt %, or 2.0 wt % to 6.5 wt %, or 4.0 wt % to 10 wt %, or 4.0 wt % to 9.5 wt %, or 4.0 wt % to 8.3 wt %, or 4.0 wt % to 6.5 wt %, or 5.5 wt % to 10 wt %, or 5.5 wt % to 9.5 wt %, or 5.5 wt % to 8.3 wt %, or 6.5 wt % to 10 wt %, or 6.5 wt % to 9.5 wt %, or 6.5 wt % to 8.3 wt %.

When forming a polymeric organosilica material, still other types of precursors/monomers can be included in the synthesis mixture, in order to provide additional types of repeat units within the resulting organosilica material. As an example, precursors can be included in the synthesis mixture to form one or more repeat units of Formula Z¹⁹Z²⁰Z²¹Si—Z²² (Formula I), wherein each Z¹⁹ represents a nitrogen-containing C₁-C₁₀ alkyl group, a nitrogen-containing heteroaralkyl group, and a nitrogen-containing optionally substituted heterocycloalkyl group; and Z²⁰, Z²¹ and Z²² are each independently selected from the group consisting of a hydrogen atom, a C₁-C₄ alkyl group or a bond to a silicon atom of another repeat unit. As another example, precursors can be included in the synthesis mixture to form one or more repeat units of Formula Z⁷Z⁸Z⁹Si—R¹—SiZ⁷Z⁸Z⁹ (Formula II), wherein each Z⁷, Z⁸ and Z⁹ independently represent a hydroxyl group, a C₁-C₄ alkoxy group or an oxygen bonded to a silicon atom of another repeat unit; and R¹ represents a C₂-C₁₀ alkylene group. In still another example, the organosilica material can be formed based on a synthesis mixture containing the alkoxy-substituted cyclic organosilane precursor, the aminosilane precursor, and precursors for forming repeat units according to both Formula I and Formula II.

In some further aspects, the organosilica material may further comprise still other types of repeat units, in addition to the repeat units based on the alkoxy-substituted cyclic organosilane precursor, the aminosilane precursor, any optional gelator, and any optional precursors for forming repeat units according to Formula I and/or Formula II. For example, the organosilica material can further comprise one or more repeat units corresponding to Formula (III) [Z¹⁰OZ¹¹SiCH₂]³, wherein each Z¹⁰ can be a hydrogen atom, a C₁-C₄ alkyl group or a bond to a silicon atom of another repeat unit and each Z¹¹ can be a hydroxyl group, a C₁-C₆ alkyl group or an oxygen atom bonded to a silicon atom of another repeat unit. As another example, the organosilica material can further comprise one or more repeat units of Formula (IV) Z¹²OZ¹³Z¹⁴Z¹⁵Si, wherein each Z¹² can be a hydrogen atom or a C₁-C₄ alkyl group or a bond to a silicon atom of another repeat unit; and Z¹³, Z¹⁴ and Z¹⁵ each independently can be selected from the group consisting of a hydroxyl group, a C₁-C₄ alkyl group, a C₁-C₄ alkoxy group and an oxygen atom bonded to a silicon atom of another repeat unit. As still another example, the organosilica material may further comprise one or more repeat unis of Formula Z¹⁶Z¹⁷Z¹⁸Si—R²—SiZ¹⁶Z¹⁷Z¹⁸ (V), wherein each Z¹⁶ independently represents a hydroxyl group, a C₁-C₄ alkoxy group or an oxygen atom bonded to a silicon atom of another repeat unit; each Z¹⁷ and Z¹⁸ independently represent a hydroxyl group, a C₁-C₄alkoxy group, a C₁-C₄alkyl group or an oxygen atom bonded to a silicon atom of another repeat unit; and each R² is selected from the group consisting a C₁-C₈ alkylene group, a C₂-C₈ alkenylene group, a C₂-C₈ alkynylene group, an optionally substituted C₆-C₂₀ aralkyl and an optionally substituted (C₄-C₂₀ heterocycloalkyl group.

### Organosilica Materials—Drying of Gel Intermediate

After forming a gel intermediate by any of the above methods, the gel intermediate can be dried in any convenient manner. In some aspects, a conventional drying method can be used, such as heating the gel intermediate to a target temperature. In other aspects, the gel intermediate can be dried using supercritical CO₂, freeze drying, or a combination thereof. Both freeze drying and drying with supercritical CO₂ can provide benefits for improving CO₂ sorption (and/or sorption of other compounds).

Conventionally, the straightforward route for drying an intermediate gel is to heat the intermediate gel to convert the solvent (such as water) in the intermediate gel into a gas, which can then be purged from the gel. Another conventional option for drying an intermediate gel after gel formation is to expose the gel to reduced pressure relative to 100 kPa-a (ambient), such as a pressure of 10 kPa-a or less, in order to convert the liquid solvent in the intermediate gel into a vapor that can then be readily purged from the gel structure using a purge gas.

For a conventional drying process, the drying is performed at a temperature of 20° C. to 300° C., or 20° C. to 150° C., or 50° C. to 300° C., or 50° C. to 150° C., or 90° C. to 300° C., or 90° C. to 150° C., or 120° C. to 300° C., or 150° C. to 300° C.

One potential difficulty with conventional drying methods is that they involve a liquid-gas phase transition for the water purged from the gel. This occurs either whether the conventional drying is performed at ambient pressure or at reduced pressure. Without being bound by any particular theory, allowing the liquid-gas phase transition to occur during the drying process appears to alter the structure, such as by reducing the pore volume and/or surface area that can be achieved in relation to the amount of nitrogen in the organosilica material. It has been discovered that drying using supercritical CO₂ can reduce, minimize, or eliminate this difficulty with the drying process. Freeze drying can also at least partially mitigate the above difficulties with the drying process.

For drying using supercritical CO₂, the drying process is started by first removing water from the intermediate gel using an alcohol, such as methanol or ethanol. After displacing water with alcohol, the gel is rinsed with high pressure liquid CO₂ to remove the alcohol. This leaves behind high pressure liquid CO₂ in the gel structure. The high pressure liquid CO₂ is then removed by increasing the temperature of the CO₂ until the temperature is above the critical point temperature of CO₂. The pressure is then reduced. The pressure reduction can be sufficient to remove the CO₂, or a purge with a suitable gas (such as nitrogen) can be performed. This results in the organosilica gel product. By increasing the temperature to above the critical point and then reducing the temperature, no phase transition occurs when changing from the initial high pressure liquid CO₂ to higher temperature, lower pressure CO₂. Avoiding this phase transition allows the CO₂ to be converted into a gas while reducing or minimizing changes to the structure of the gel. It is noted that the critical point for CO₂ is roughly 31° C. and 7.39 MPa.

During a supercritical CO₂ drying process, the initial displacement of water via solvent exchange with alcohol can be performed using any convenient small alcohol or mixture of small alcohols. Examples of suitable alcohols include, but are not limited to, methanol, ethanol, n-propyl alcohol, isopropyl alcohol, C₄ alcohol, and combinations thereof. More generally, the alcohol can correspond to an alcohol (or mixture of alcohols) where the alcohol does not freeze at −57° C., which is the minimum temperature for formation of liquid CO₂. The initial alcohol solvent exchange can be performed at a temperature of 0° C. to 30° C., or 5° C. to 30° C. It is noted that the solvent exchange should be performed at a high enough temperature that the water within the intermediate gel does not freeze. Any convenient pressure can be used for the alcohol solvent exchange. In some aspects, the alcohol solvent exchange can be performed at roughly ambient pressure, so a pressure of roughly 90 kPa-a or more, or 100 kPa-a or more. In other aspects, it can be convenient to perform the alcohol solvent exchange at a pressure that is similar to the pressure that will be used for the initial introduction of liquid CO₂ into the gel. In such aspects, the pressure during the alcohol solvent exchange can be 0.8 MPa-a or higher, or 2.0 MPa-a or higher, or 4.0 MPa-a or higher or 7.4 MPa-a or higher, such as up to 10 MPa-a or possibly still higher. The solvent exchange can be performed for a sufficient amount of time to remove substantially all of the water from the gel structure. In some aspects, the solvent exchange with alcohol can be performed for 0.5 hours to 24 hours, or 1.0 hours to 24 hours, or 0.5 hours to 12 hours, or 1.0 hours to 12 hours. In some aspects, this can correspond to performing a plurality of washes with alcohol, such as up to 5, or up to 10.

After solvent exchange with alcohol, a second wash can be performed with fluid CO₂, such as liquid CO₂ and/or supercritical CO₂. Because the small alcohols used in the alcohol solvent exchange have lower freezing points than water, the gel can be washed with the fluid CO₂ at a temperature between −59° C. and 5.0° C. During the wash with fluid CO₂, the pressure can be any convenient pressure where the CO₂ is in a liquid state (or optionally a supercritical state) based on the temperature. In various aspects, the pressure during the liquid CO₂ wash step can be 0.8 MPa-a or higher, or 2.0 MPa-a or higher, or 4.0 MPa-a or higher or 7.4 MPa-a or higher, such as up to 10 MPa-a or possibly still higher. The wash can be performed for a sufficient amount of time to remove substantially all of the alcohol wash from the gel structure. In some aspects, the wash with fluid CO₂ can be performed for 1.0 hours to 12 hours, or 1.0 hours to 8.0 hours, or 1.0 hours to 4.0 hours, or 2.0 hours to 12 hours, or 2.0 hours to 8.0 hours, or 2.0 hours to 4.0 hours. Optionally, the wash with fluid CO₂ can be performed iteratively, with between 1-3 washes with CO₂ being performed before proceeding to the next step.

After washing with CO₂, the pressure in the wash environment can be increased so that the pressure is above the critical point for CO₂. The corresponds to increasing the pressure to 7.4 MPa-a or more. Higher values of pressure can be used, so long as the pressure does not cause substantial collapse of the gel structure. Thus, pressures of up to 20 MPa-a can be used, although achieving such pressures that are substantially above the critical point incurs additional energy cost with little or no additional benefit. It is noted that the increase in pressure can be performed in any convenient manner, so long as the CO₂ does not undergo a phase transition to a solid or a gas during the increase. It is further noted that if the pressure during the CO₂ was 7.4 MPa-a or higher, then no further pressure increase is needed.

The temperature in the wash environment can also be increased so that the temperature is above the critical point for CO₂. This corresponds to increasing the temperature to 31° C. or more. Higher values of temperature can be used (such as up to 70° C.) although achieving such temperatures that are substantially above the critical point incurs additional energy cost with little or no additional benefit. In some aspects, the increase in pressure and temperature can be performed sequentially, so that the pressure is increased first, and then the temperature is increased. In other aspects, the temperature and pressure increase(s) can be performed in any convenient manner, so long as no phase transition for CO₂ occurs during the increase(s) in temperature and pressure. It is noted that the path to achieving the pressure and temperature combination that is greater than the critical point for CO₂ may include steps where the pressure or temperature are decreased.

After increasing the temperature and/or pressure in the wash environment to a combination of temperature and pressure beyond the CO₂ critical point, the pressure can be decreased while the temperature remains above the critical point so that the CO₂ is in the “gas phase” portion of the phase diagram after decreasing the pressure. Once the pressure in the wash environment is in the “gas phase” portion of the phase diagram, any convenient combination of temperature and/or pressure changes can be used to reduce the density of the CO₂ to a point where the CO₂ can be removed. In some aspects, the CO₂ can be purged with a purge stream (such as N₂ or air). Additionally or alternately, the pressure can be reduced to a pressure below 100 kPa-a, or below 90 kPa-a, such as down to 1.0 kPa-a or possibly still lower, to remove the CO₂ in a vacuum environment. Of course, a combination of a purge gas and a reduced pressure environment can also be used. Still another option is to vent the CO₂, without the need for either a purge or reducing the pressure below 100 kPa-a.

Freeze drying provides an alternative method of trying to avoid a liquid-gas phase transition while removing liquids from the gel structure. Instead of going around the supercritical point, a freeze drying process converts the liquid in the gel to a solid, and then removes the solid via a solid-gas phase transition. There are several options for performing the freeze drying. One option is to directly freeze the water in the gel, and then reduce the pressure in the wash environment to a sufficiently low pressure that the ice sublimates (i.e., passes directly from solid to gas phase). Alternatively, the water can be removed by rinsing with one or more secondary wash mediums, such as small alcohols or CO₂. The temperature and pressure can then be modified so that the secondary wash medium remaining in the gel is converted to a solid, followed by a second modification of the pressure to sublimate the solid to a gas. It is noted that some disruption of the resulting gel structure can still occur during the solid-gas phase transition in the freeze-drying method. After sublimating the wash medium, the gas can be removed from the gel by reducing the pressure to 70 kPa-a or less, or 50 kPa-a or less, such as down to 1.0 kPa-a or possibly still lower. Optionally, a purge gas (such as N₂ or air) can be used to assist with removing the gas from the gel structure.

### Characterization of Organosilica Materials

The organosilica materials made by the methods described herein can be characterized as described in the following sections.

### A. X-Ray Diffraction Peaks

In some aspects, the organosilica materials described herein can exhibit powder X-ray diffraction patterns with one broad peak between about 1 and about 4 degrees 2θ, particularly one peak between about 1 and about 3 degrees 2θ. Additionally or alternatively, in the 0.5 to 12 degrees 2θ range, the organosilica materials can exhibit substantially no peaks, or in the range of about 3 to about 12 degrees 2θ, about 4 to about 12 degrees 2θ, in the range of about 5 to about 12 degrees 2θ, in the range of about 6 to about 12 degrees 2θ, in the range of about 7 to about 12 degrees 2θ, in the range of about 8 to about 12 degrees 2θ, in the range of about 9 to about 12 degrees 2θ, in the range of about 10 to about 12 degrees 2θ, or in the range of about 11 to about 12 degrees 2θ.

### B. Pore Size

The pore size of the organosilica materials can vary depending on the nature of the synthesis, including the nature of the drying method. The materials can generally be in a mesoporous form. As indicated previously, the term mesoporous refers to solid materials having pores with a diameter within the range of from about 2 nm to about 50 nm. Materials dried by other methods may be in mesoporous form, or the pore average pore size may be as low as 1.0 nm. In this discussion, the average pore diameter of the organosilica material can be determined based on a procedure similar to the procedure in UOP 425, but with an activation procedure that corresponded to exposing the material to a temperature of 140° C. for 4 hours under vacuum prior to obtaining an isotherm. It is noted that this modified version of UOP 425 is used herein even for pore sizes below 1.0 nm.

For materials dried using supercritical CO₂, the organosilica material can have an average pore diameter of 2.0 nm to 50 nm, or 2.0 nm to 20 nm, or 2.0 nm to 10 nm, or 5.0 nm to 50 nm, or 5.0 nm to 20 nm, or 10 nm to 50 nm. In some alternative aspects, the organosilica material can have sufficient micropore volume that the average pore diameter may be less than 2.0 nm. Thus, in some alternative aspects, the organosilica material can have an average pore diameter of 1.2 nm to 20 nm, or 1.2 nm to 10 nm, or 1.2 nm to 5.0 nm, or 1.5 nm to 20 nm, or 1.5 nm to 10 nm, or 1.5 nm to 5.0 nm, or 2.0 nm to 5.0 nm.

More generally, the organosilica material can have an average pore diameter of 0.5 nm to 50 nm, or 0.5 nm to 20 nm, or 0.5 nm to 10 nm, or 1.0 nm to 50 nm, or 1.0 nm to 20 nm, or 2.0 nm to 50 nm, or 2.0 nm to 20 nm, or 2.0 nm to 10 nm, or 5.0 nm to 50 nm, or 5.0 nm to 20 nm, or 10 nm to 50 nm.

### C. Surface Area

The surface area of the organosilica material can be determined, for example, using nitrogen adsorption-desorption isotherm techniques within the expertise of one of skill in the art, such as the BET (Brunauer Emmet Teller) method in ASTM UOP 425. This method may determine a total surface area, an external surface area, and a microporous surface area. As used herein, and unless otherwise specified, “total surface area” refers to the total surface area as determined by the BET method. As used herein, and unless otherwise specified, “microporous surface area” refers to microporous surface are as determined by the BET method in ASTM UOP 425, with the modification to the activation procedure (4 hours at 140° C. under vacuum) described above.

In various aspects, the organosilica material can have a total surface area of 100 m²/g to about 2,000 m²/g, or 100 m²/g to 1,500 m²/g, or 100 m²/g to 1000 m²/g, or 100 m²/g to 500 m²/g, or 200 m²/g to about 2,000 m²/g, or 200 m²/g to 1,500 m²/g, or 200 m²/g to 1000 m²/g, or 400 m²/g to 2,000 m²/g, or 400 m²/g to about 1,500 m²/g, or 400 m²/g to 1000 m²/g, or 600 m²/g to 2,000 m²/g, or 600 m²/g to 1,500 m²/g, or 800 m²/g to 2000 m²/g, or 800 m²/g to 1,500 m²/g.

### D. Pore Volume

The pore volume of the organosilica material can be determined according to the method in ASTM UOP 425, with the modification to the activation procedure (4 hours at 140° C. under vacuum) described above. In some aspects, the organosilica material can have a pore volume of 0.15 cm³/g to 3.0 cm³/g, or 0.15 cm³/g to 2.7 cm³/g, or 0.15 cm³/g to 2.0 cm³/g, or 0.15 cm³/g to 1.0 cm³/g, or 0.35 cm³/g to 3.0 cm³/g, or 0.35 cm³/g to 2.7 cm³/g, or 0.35 cm³/g to 2.0 cm³/g, or 0.35 cm³/g to 1.0 cm³/g, or 0.75 cm³/g to 3.0 cm³/g, or 1.0 cm³/g to 3.0 cm³/g, or 1.5 cm³/g to 3.0 cm³/g, or 2.0 cm³/g to 3.0 cm³/g, or 0.75 cm³/g to 2.7 cm³/g, or 1.0 cm³/g to 2.7 cm³/g, or 1.5 cm³/g to 2.7 cm³/g, or 2.0 cm³/g to 2.7 cm³/g.

### E. Gas Separation Processes—Separation of CO₂ for Carbon Capture

In some aspects, an organosilica material can be used in a gas separation process. The gas separation process can comprise contacting a gas mixture containing at least one contaminant with the organosilica material.

As an example, one type of separation can be a method for abating CO₂ from a flue gas in which the flue gas is contacted with an amine-functionalized organosilica material as described herein to reversibly adsorb CO₂ from the flue gas, capturing >80% by volume, preferably >95% by volume, thereby generating an adsorption material enriched for CO₂, and then stripping a major portion of the CO₂ from the adsorption material enriched for CO₂ using a temperature swing adsorption method, vacuum swing adsorption method, a pressure swing adsorption method, a concentration swing adsorption method, or a combination thereof.

Another type of separation can be a method for capturing CO₂ from air, also known as direct air capture, in which air is contacted with an amine-functionalized organosilica material as described herein to reversibly adsorb CO₂ from air, capturing >50% by volume, preferable >75% by volume, CO₂ emissions, or stated differently, reducing CO₂ concentrations in air to less than about 200 ppmv, preferably to less than 100 ppmv, resulting in direct CO₂ capture from the air, thereby generating an adsorption material enriched with CO₂. It would be understood by a person of skill in the art that as the base concentration changes, the capture rate also changes. A major portion of the CO₂ can then stripped from the adsorption material enriched for CO₂ using a temperature swing adsorption method, vacuum swing adsorption method, a pressure swing adsorption method, a concentration swing adsorption method, or a combination thereof.

Still another type of application is carbon capture from powerplant exhaust, such as coal flue gas. The increasing atmospheric levels of carbon dioxide (CO₂), which are likely contributing to global climate change, warrant new strategies for reducing CO₂ emissions from point sources such as power plants. In particular, coal-fueled power plants are responsible for a substantial portion of global anthropogenic energy supply CO₂ emissions. Thus, there remains a continuing need for the development of new adsorbents for carbon capture from coal flue gas. An example of a gas stream corresponding to a coal flue gas can include CO₂ (˜15-16%), O₂ (˜3-4%), H₂O (˜5-7%), N₂ (˜70-75%), and trace impurities (e.g. SO₂, NOₓ) at ambient pressure and 40° C. For a temperature swing adsorption process for separating CO₂ from a flue gas (such as coal flue gas), it can be beneficial to have an adsorbent that possesses one or more the following properties: (a) a high working capacity with a minimal temperature swing, in order to minimize regeneration energy costs; (b) high selectivity for CO₂ over the other constituents of coal flue gas; (c) 90% (or greater) capture of CO₂ under flue gas conditions; (d) effective performance under humid conditions; and (d) long-term stability to adsorption/desorption cycling under humid conditions.

More generally, another example of a separation can be a method for abating CO₂ from a flue gas, such as natural gas flue gas. Generally, a combustion flue gas can correspond to a gas containing 4.0 vol % or more of CO₂, with higher CO₂ concentrations possible for flue gases formed by burning hydrocarbons other than methane or natural gas, such as coal or heavy oils. In such embodiments, the flue gas is contacted with an amine-functionalized organosilica material as described herein to reversibly adsorb CO₂ from the flue gas thereby generating an adsorption material enriched for CO₂ and then stripping a major portion of the CO₂ from the adsorption material enriched for CO₂ using a using a temperature swing adsorption method, vacuum swing adsorption method, a pressure swing adsorption method, a concentration swing adsorption method, or a combination thereof.

In some aspects, a separation can be used to capture carbon dioxide produced by a source. In such aspects, a method can include exposing the carbon dioxide to an amine-functionalized organosilica material as described herein whereby the carbon dioxide is reversibly bound onto the adsorption material. In some such embodiments, the method further comprises regenerating the adsorption material enriched for CO₂ using a temperature swing adsorption method, vacuum swing adsorption method, a pressure swing adsorption method, a concentration swing adsorption method, or a combination thereof.

More generally, in some aspects, an amine-functionalized organosilica material as described herein can be used in a method of capturing carbon dioxide from a multi-component gas mixture. In such aspects, a multi-component gas mixture can include CO₂ and at least one of N₂, H₂O, and O₂. The multi-component gas mixture is exposed to an amine-functionalized organosilica material as described herein whereby a least fifty percent, at least sixty percent, or at least eighty percent of the carbon dioxide within the multi-component gas mixture is reversibly bound onto the adsorption material. In some such embodiments, the method further comprises regenerating the adsorption material enriched for CO₂ using a temperature swing adsorption method, vacuum swing adsorption method, a pressure swing adsorption method, a concentration swing adsorption method, or a combination thereof.

### Examples—General Methods

CO₂ adsorption work was done with a Autosorb-1. All the samples were pre-treated at 140° C. in vacuum for 4 hours before collecting the CO₂ isotherm at different temperatures.

The nitrogen adsorption/desorption analyses was performed with a Quantchrome autosorb iQ2 instrument. All the samples were pre-treated at 140° C. in vacuum for 4 hours before collecting the N₂ isotherm. The analysis program calculated the experimental data and reported BET surface area (total surface area), microporous surface area (S), total pore volume, pore volume for micropores, average pore diameter (or radius), etc.

### Examples—Characterization of Amine-Functionalized Organosilica Materials

The amine-functionalized organosilica materials in these examples were made according to two methods. One set of samples was made using the method illustrated in FIG. 4. As shown in FIG. 4, the alkoxy-substituted cyclic organosilane “3R” was combined with an aminosilane, optionally along with a gelator. FIG. 4 shows an example synthesis of amine-functionalized organosilicas that were made using aminosilanes with only primary amines, but organosilicas with also made using other aminosilanes precursors to allow for comparative testing. The molar ratios of the components for the condensation to make the gel were 1:0.5-3.0:0-0.5 for 3R:aminosilane:gelator. Sufficient base was also added to bring the pH of the condensation mixture to roughly 10.5. The condensation mixture was then stirred at room temperature overnight. The resulting sol was then heated in an autoclave (rotating or stationary) at 90° C. overnight to form the gel. The samples were then dried using supercritical CO₂ drying.

For the second set of samples, similar synthesis conditions were used, but a different type of drying was performed. Instead of using supercritical CO₂ for drying, the samples were placed in a vacuum oven, evacuated and held at 60° C. for 1-2 days. The pressure during the vacuum drying was not fully characterized, but is believed that the pressure in the oven during vacuum drying was less than 40 kPa-a.

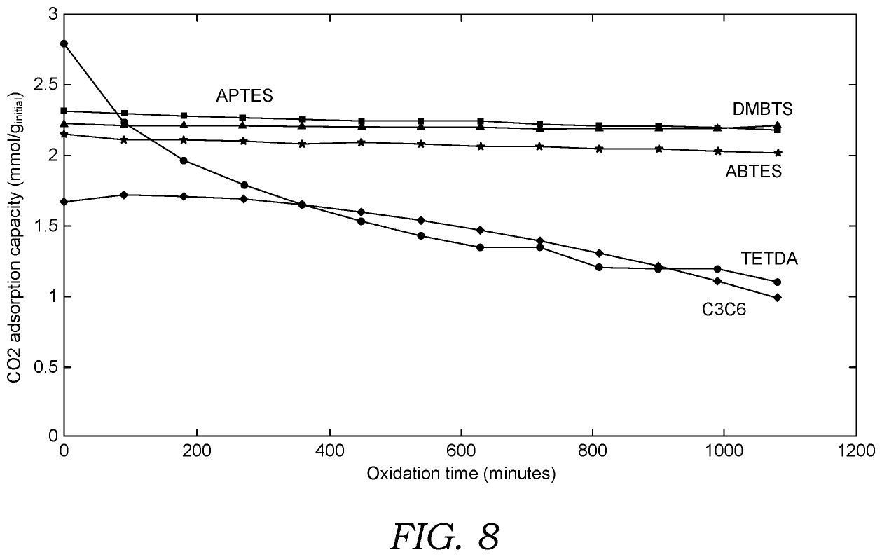

The samples were then characterized to determine oxidative stability. Oxidative stability was evaluated using in situ accelerated aging tests. For in situ oxidative stability evaluation, samples were submitted to several cycles of accelerated aging in a TGA instrument. For these tests, samples were activated at 110° C. under N₂ for 3 hours, then cooled to 35° C. and the gas switched to 100% CO₂. After this, the sample was submitted to repeated cycles of heating to 140° C. in air for 90 min followed by cooling under N₂ to 35° C., when the gas was switched to 100% CO₂ to check capacity. Table 1 shows results from testing the first set of samples that were dried using supercritical CO₂. FIG. 8 shows the underlying data of CO₂ capacity versus oxidation time that is summarized in Table 1.

TABLE 1
In-Situ Oxidative Stability for Supercritical CO₂ Dried Samples

| | | | CO2 | | |
|---|---|---|---|---|---|
| | | | Capacity | | |
| | | | after 12 | | |
| | | Pristine | cycles (18 | | |
| | | CO2 | hrs of | Capacity | Oxidation |
| | Aminosilane | capacity | oxidation) | Retained | temp |
| Type | precursor | mmol/g | mmol/g | % | degrees C. |
| Comparative | C2C3 | 2.8 | 1.2 | 42 | 140 |
| Comparative | C3C6 | 1.7 | 1.0 | 59 | 140 |
| Inventive | APTES | 2.3 | 2.2 | 96 | 140 |
| Inventive | ABTES | 2.2 | 2.0 | 91 | 140 |
| Inventive | DMBTS | 2.25 | 2.20 | 98 | 140 |

As shown in Table 1, two comparative amine-functionalized organosilicas were tested that were formed using aminosilane precursors that included secondary amines from the structures shown in FIG. 3 (C2C3 and C3C6). Three additional amine-functionalized organosilicas were tested based on the aminosilane precursors shown in FIG. 2 (ABTES and DMBTS), plus the aminosilane precursor APTES.

As shown in Table 1, the comparative amine-functionalized organosilicas lost substantial portions of their original capacity after cyclic exposure to an oxidizing environment under CO₂ sorption and desorption conditions. By contrast, the amine-functionalized organosilicas that included only primary amines unexpectedly retained 90% or more of their original CO₂ capacity after 18 hours of testing. This demonstrates the benefit of using amine-functionalized organosilicas having only primary amines when performing CO₂ sorption and desorption in the presence of oxygen. It is noted that oxygen would be present during a sorption/desorption cycle for capture of CO₂ from air, or from CO₂-containing flue gases where air is used as the oxygen source.

In addition to the benefits of using amine-functionalized organosilicas based on primary amines, additional benefits are realized when using amine-functionalized organosilicas based on primary amines that do not include hydrogens on the beta carbon relative to the primary amine. For the samples shown in Table 1, organosilicas formed using APTES and ABTES correspond to amine-functionalized organosilicas that have hydrogens on the beta carbon relative to the primary amine. This is in contrast to organosilicas formed using DMBTS, which has no hydrogens on the beta carbon relative to the primary amine. As shown in Table 1, the organosilica formed using DMBTS unexpectedly provided further oxidative stability relative to the organosilicas formed using APTES and ABTES.

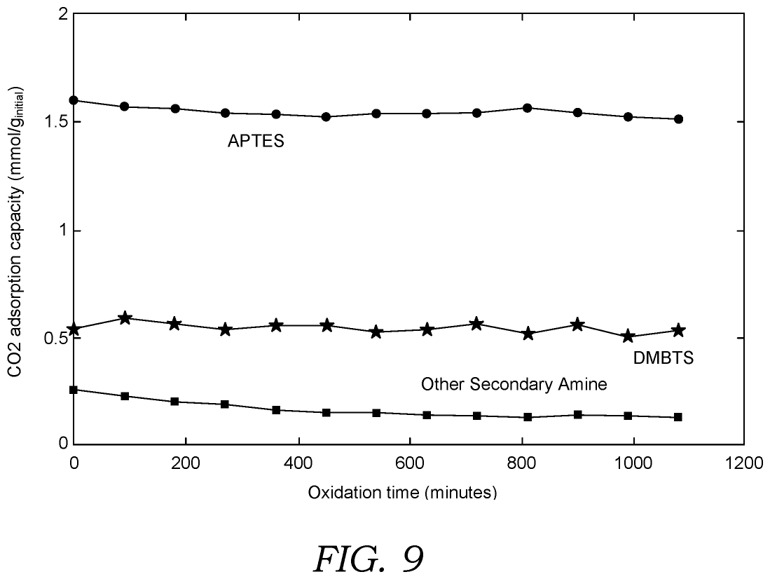

Oxidative stability testing was also performed on the second set of samples that were dried using the vacuum oven drying procedure. Table 2 shows results from testing the second set of samples that were dried using vacuum oven drying. FIG. 9 shows the underlying data of CO₂ capacity versus oxidation time that is summarized in Table 2. For the second set of samples, organosilicas were formed using APTES, DMBTS, and the amine precursor N,N′-bis[(3-trimethoxysilyl)propyl]ethylenediamine, which is an amine precursor that only includes secondary amines. As shown in Table 2 and in FIG. 9, the organosilica samples produced using the vacuum drying method had lower CO₂ sorption capacities, but the samples using APTES and DMBTS retained their capacities over time, indicating oxidative stability.

TABLE 2
In-Situ Oxidative Stability for Vacuum Oven Dried Samples

| | | | CO2 | | |
|---|---|---|---|---|---|
| | | | Capacity | | |
| | | | after 12 | | |
| | | Pristine | cycles (18 | | |
| | | CO2 | hrs of | Capacity | Oxidation |
| | | capacity | oxidation) | Retained | temp |
| Type | Aminosilane precursor | mmol/g | mmol/g | % | degrees C. |
| Comparative | N,N′-bis [(3- | 0.25 | 0.15 | 60 | 140 |
| | trimethoxysilyl)propyl]ethylenediamine | | | | |
| Inventive | APTES | 1.56 | 1.51 | 97 | 140 |
| Inventive | DMBTS | 0.52 | 0.51 | 98 | 140 |

### Additional Embodiments

Embodiment 1. A method for performing sorption and desorption of CO₂ in an oxidizing environment, comprising: providing an organosilica material comprising a polymer of one or more repeat units of Formula (1),

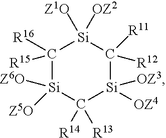

the organosilica material having a nitrogen content of 2.0 wt % to 9.5 wt %, a surface area of 100 m²/g or more, and a pore volume of 0.15 cm³/g or more, the organosilica material comprising primary amines while being substantially free of secondary amines; exposing the organosilica material to CO₂ under sorption conditions comprising a sorption temperature and a sorption pressure to form an organosilica material comprising sorbed CO₂; and desorbing at least a portion of the sorbed CO₂ under desorption conditions comprising at least one of a desorption temperature higher than the sorption temperature and a desorption pressure lower than the sorption pressure, wherein a) the sorption conditions comprise a sorption atmosphere containing 1.0 vol % or more of O₂, b) the desorption conditions comprises a desorption atmosphere containing 1.0 vol % or more of 02, or c) a combination of a) and b), wherein Z¹, Z², Z³, Z⁴, Z⁵, and Z⁶ each independently represent a hydrogen atom, a C₁-C₄ alkyl group, a bond to a silicon atom of another repeat unit of Formula (1), a bond to an aminosilyl group comprising a primary amine, a bond to a silicon atom that is bonded to three alkoxy groups, or a bond to a silicon atom of a secondary repeat unit, the secondary repeat unit optionally comprising an acyclic alkoxy silane, and wherein R¹¹, R¹², R¹³, R¹⁴, R¹⁵, and R¹⁶ each independently represent a hydrogen atom or a C₁-C₄ alkyl group.

Embodiment 2. The method of Embodiment 1, i) wherein the organosilica material comprises primary amines with beta carbons that are not bonded to hydrogens; ii) wherein the aminosilyl group comprising a primary amine is selected from the group consisting of aminopropyl silane, aminobutyl silane, 2,2-dimethyl-aminobutyl silane, or a combination thereof; or iii) a combination of i) and ii).

Embodiment 3. The method of any of the above embodiments, wherein the sorption conditions comprise a sorption temperature of 0° C. to 50° C., the sorption atmosphere containing 300 vppm to 3000 vppm of CO₂, the sorption atmosphere optionally further comprising 5.0 vol % to 22 vol % of O₂.

Embodiment 4. The method of any of the above embodiments, wherein the sorption conditions comprise a sorption temperature of 0° C. to 75° C., the sorption atmosphere containing 1.0 vol % to 20 vol % of CO₂, the sorption atmosphere optionally further comprising 1.0 vol % to 10 vol % of O₂.

Embodiment 5. The method of any of the above embodiments, wherein the desorption conditions comprise a desorption temperature of 80° C. to 160° C.

Embodiment 6. The method of any of the above embodiments, wherein the sorption atmosphere comprises 10 vol % to 22 vol % O₂, preferably 15 vol % to 22 vol % O₂.

Embodiment 7. The method of any of the above embodiments, the method further comprising forming the organosilica material, the forming comprising: condensing an alkoxy-substituted cyclic organosilane in the presence of at least one aminosilane precursor to form a gel intermediate; and drying the gel intermediate, the at least one aminosilane precursor optionally being selected from the group consisting of aminobutyl-triethoxysilane, aminopropyl-trethoxysilane, dimethyl-aminobutyl-triethoxysilane, and combinations thereof.

Embodiment 8. The method of Embodiment 7, wherein the alkoxy-substituted cyclic organosilane is condensed in the presence of at least one aminosilane precursor and i) a gelator, ii) one or more additional precursors that form one or more secondary repeat units during the condensation, or c) a combination of a) and b).

Embodiment 9. The method of any of Embodiments 7 to 8, wherein drying the gel intermediate comprises using a supercritical CO₂ drying process, a freeze drying process, a drying process performed at a pressure of 40 kPa-a or less, or a combination thereof.

Embodiment 10. The method of any of the above embodiments, wherein the nitrogen content of the organosilica material is 3.0 wt % to 9.5 wt %, or wherein the nitrogen content of the organosilica material is 2.0 wt % to 6.5 wt %.

Embodiment 11. The method of any of the above embodiments, wherein the organosilica material comprises a surface area of 200 m²/g or more, preferably 300 m²/g or more; or wherein the organosilica material comprises a pore volume of 0.35 cm³/g or more, preferably 0.75 cm³/g or more; or a combination thereof.

Embodiment 12. The method of any of the above embodiments, wherein R¹¹, R¹², R¹³, R¹⁴, R¹⁵, and R¹⁶ each represent a hydrogen atom.

Embodiment 13. An organosilica material comprising a polymer of at least one repeat unit of Formula (1),

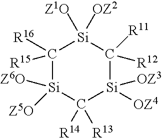

wherein Z¹, Z², Z³, Z⁴, Z⁵, and Z⁶ each independently represent a hydrogen atom, a C₁-C₄ alkyl group, a bond to a silicon atom of another repeat unit of Formula (1), a bond to an aminosilyl group having a primary amine with a beta carbon that is not bonded to hydrogens, a bond to a silicon atom that is bonded to three alkoxy groups, or a bond to a silicon atom of a secondary repeat unit, the secondary repeat unit optionally comprising an acyclic alkoxy silane, wherein R¹¹, R¹², R¹³, R¹⁴, R¹⁵, and R¹⁶ each independently represent a hydrogen atom or a C₁-C₄ alkyl group, the organosilica material being substantially free of secondary amines, and wherein the organosilica material comprises a nitrogen content of 2.0 wt % to 9.5 wt %, a surface area of 100 m²/g or more, and a pore volume of 0.15 cm³/g or more.

Embodiment 14. The organosilica material of Embodiment 13, wherein the nitrogen content is 6.5 wt % to 9.5 wt %, preferably 4.4 wt % to 8.0 wt %; or wherein the organosilica material comprises a surface area of 200 m²/g or more and a pore volume of 0.35 cm³/g or more; or a combination thereof.

Embodiment 15. The organosilica material of any of Embodiments 13 to 14, wherein the aminosilyl group having a primary amine with a beta carbon that is not bonded to hydrogens is 2,2-dimethyl-aminobutyl silane, and optionally wherein R^{D}, R¹², R¹³, R¹⁴, R¹⁵, and R¹⁶ each represent a hydrogen atom.

All numerical values within the detailed description and the claims herein are modified by “about” or “approximately” the indicated value, and take into account experimental error and variations that would be expected by a person having ordinary skill in the art.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. A method for performing sorption and desorption of CO₂ in an oxidizing environment, comprising:
providing an organosilica material comprising a polymer of one or more repeat units of Formula (1), 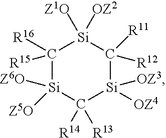
the organosilica material having a nitrogen content of 2.0 wt % to 9.5 wt %, a surface area of 100 m²/g or more, and a pore volume of 0.15 cm³/g or more, the organosilica material comprising primary amines while being substantially free of secondary amines;
exposing the organosilica material to CO₂ under sorption conditions comprising a sorption temperature and a sorption pressure to form an organosilica material comprising sorbed CO₂; and
desorbing at least a portion of the sorbed CO₂ under desorption conditions comprising at least one of a desorption temperature higher than the sorption temperature and a desorption pressure lower than the sorption pressure,
wherein a) the sorption conditions comprise a sorption atmosphere containing 1.0 vol % or more of O₂, b) the desorption conditions comprises a desorption atmosphere containing 1.0 vol % or more of O₂, or c) a combination of a) and b),
wherein Z¹, Z², Z³, Z⁴, Z⁵, and Z⁶ each independently represent a hydrogen atom, a C₁-C₄ alkyl group, a bond to a silicon atom of another repeat unit of Formula (1), a bond to an aminosilyl group comprising a primary amine, a bond to a silicon atom that is bonded to three alkoxy groups, or a bond to a silicon atom of a secondary repeat unit, the secondary repeat unit optionally comprising an acyclic alkoxy silane, and
wherein R¹¹, R¹², R¹³, R¹⁴, R¹⁵, and R¹⁶ each independently represent a hydrogen atom or a C₁-C₄ alkyl group.

2. The method of claim 1, wherein the organosilica material comprises primary amines with beta carbons that are not bonded to hydrogens.

3. The method of claim 1, wherein the aminosilyl group comprising a primary amine is selected from the group consisting of aminopropyl silane, aminobutyl silane, 2,2-dimethyl-aminobutyl silane, or a combination thereof.

4. The method of claim 1, wherein the sorption conditions comprise a sorption temperature of 0° C. to 50° C., the sorption atmosphere containing 300 vppm to 3000 vppm of CO₂.

5. The method of claim 4, wherein the sorption atmosphere further comprises 5.0 vol % to 22 vol % of O₂.

6. The method of claim 1, wherein the sorption conditions comprise a sorption temperature of 0° C. to 75° C., the sorption atmosphere containing 1.0 vol % to 20 vol % of CO₂.

7. The method of claim 6, wherein the sorption atmosphere further comprises 1.0 vol % to 10 vol % of O₂.

8. The method of claim 1, wherein the desorption conditions comprise a desorption temperature of 80° C. to 160° C.

9. The method of claim 1, wherein the sorption atmosphere comprises 10 vol % to 22 vol % O₂, or 15 vol % to 22 vol % O₂.

10. The method of claim 1, the method further comprising forming the organosilica material, the forming comprising:
condensing an alkoxy-substituted cyclic organosilane in the presence of at least one aminosilane precursor to form a gel intermediate; and
drying the gel intermediate.

11. The method of claim 10, wherein the at least one aminosilane precursor is selected from the group consisting of aminobutyl-triethoxysilane, aminopropyl-trethoxysilane, dimethyl-aminobutyl-triethoxysilane, and combinations thereof.

12. The method of claim 10, wherein the alkoxy-substituted cyclic organosilane is condensed in the presence of at least one aminosilane precursor and i) a gelator, ii) one or more additional precursors that form one or more secondary repeat units during the condensation, or c) a combination of a) and b).

13. The method of claim 10, wherein drying the gel intermediate comprises using a supercritical CO₂ drying process, a freeze drying process, a drying process performed at a pressure of 40 kPa-a or less, or a combination thereof.

14. The method of claim 1, wherein the nitrogen content of the organosilica material is 3.0 wt % to 9.5 wt %, or wherein the nitrogen content of the organosilica material is 2.0 wt % to 6.5 wt %.

15. The method of claim 1, wherein the organosilica material comprises a surface area of 200 m²/g or more, or wherein the organosilica material comprises a pore volume of 0.35 cm³/g or more, or a combination thereof.

16. The method of claim 1, wherein the organosilica material comprises a surface area of 300 m²/g or more, or wherein the organosilica material comprises a pore volume of 0.75 cm³/g or more, or a combination thereof.

17. The method of claim 1, wherein R^{D}, R¹², R¹³, R¹⁴, R¹⁵, and R¹⁶ each represent a hydrogen atom.

18. An organosilica material comprising a polymer of at least one repeat unit of Formula (1), 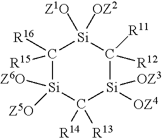
wherein Z¹, Z², Z³, Z⁴, Z⁵, and Z⁶ each independently represent a hydrogen atom, a C₁-C₄ alkyl group, a bond to a silicon atom of another repeat unit of Formula (1), a bond to an aminosilyl group having a primary amine with a beta carbon that is not bonded to hydrogens, a bond to a silicon atom that is bonded to three alkoxy groups, or a bond to a silicon atom of a secondary repeat unit, the secondary repeat unit optionally comprising an acyclic alkoxy silane,
wherein R¹¹, R¹², R¹³, R¹⁴, R¹⁵, and R¹⁶ each independently represent a hydrogen atom or a C₁-C₄ alkyl group,
the organosilica material being substantially free of secondary amines, and
wherein the organosilica material comprises a nitrogen content of 2.0 wt % to 9.5 wt %, a surface area of 100 m²/g or more, and a pore volume of 0.15 cm³/g or more.

19. The organosilica material of claim 18, wherein the nitrogen content is 6.5 wt % to 9.5 wt %.

20. The organosilica material of claim 18, wherein the nitrogen content is 4.4 wt % to 8.0 wt %.

21. The organosilica material of claim 18, wherein the organosilica material comprises a surface area of 200 m²/g or more and a pore volume of 0.35 cm³/g or more.

22. The organosilica material of claim 18, wherein R¹¹, R¹², R¹³, R¹⁴, R¹⁵, and R¹⁶ each represent a hydrogen atom.

23. The organosilica material of claim 18, wherein the aminosilyl group is 2,2-dimethyl-aminobutyl silane.
